(19) United States
(12) Patent Application Publication
(10) Pub. No.: US 2015/0140916 A1
(43) Pub. Date: May 21, 2015

(54) Hinged vent unit

(71) Applicants: Randy A. Bickel, Edwardsburg, MI (US); Matthew J. Copeland, Middlebury, IN (US)

(72) Inventors: Randy A. Bickel, Edwardsburg, MI (US); Matthew J. Copeland, Middlebury, IN (US)

(21) Appl. No.: 13/998,673

(22) Filed: Nov. 21, 2013

(51) Int. Cl. B60H 1/26; B60H 1/34

(52) U.S. Cl. CPC B60H 1/262; B60H 1/34
USPC 454/136; 454/145

(57) ABSTRACT

A hinged vent unit is provided having a dome member, connected to a frame for mounting to a vehicle, which is selectively manipulable by an arm connected at or near one end thereof to the dome and connected at another portion thereof to a plurality of selectively engageable stops which, when connected to the arm, prevent the dome from moving relative to the frame.

### BACKGROUND

Ventilators are commonly used to provide air intake and outlet and/or light to compartment spaces of vehicles, such as recreational vehicles, cargo trailers, truck cabs and other enclosed cab or vehicle spaces. Such ventilators (hereinafter, “vents”) may be mounted with a wall, ceiling or roof of the vehicle space, and must seal well enough to prevent air, water, dust and other environmental elements from entering the vehicle when the vents are shut.

Various vents are described in the prior art. U.S. Pat. No. 6,932,694 to Jeffries (“Jeffries”) discloses a selectively adjustable vent that is opened or closed via a squeezable handle. A user squeezes the handle to release a locking rod from holding channels of opposing receivers. Pushing up on the handle while maintaining squeezing pressure allows the rod to travel upward within internal tracks of the receivers. Support members connected with the handle press upwards on a cover of the vent, causing the vent cover to pivot open. Releasing pressure on the handle allows the internal rod to settle in one of several alternate channels within the receiver tracks, to secure the vent in a selected open position.

U.S. Pat. No. 3,401,620 to Armstrong (“Armstrong”) et al. discloses a vent that is mounted with a vehicle roof such that an internal knob protrudes into the vehicle space. A user turns the knob to activate a screw that extends through the vehicle roof and pushes upward on a forward end of a damper within the vent housing. Turning the knob upward (i.e., tightening) pushes the internal screw into the forward end of the damper, causing the damper to pivot on a pivot pin to open an air intake chamber within the vent housing. Turning the knob in the opposite direction (i.e., loosening) releases the internal screw from the forward end of the damper. An internal spring biases the forward end of the damper downward, closing the air intake chamber and opening an outlet chamber for venting air from within the vehicle space to the outside environment.

U.S. Pat. No. 3,672,291 to Kujawa (“Kujawa”) discloses a ventilator unit with dual pivoting handles attached to arm and crank units. Operation of the handles allows selective positioning of opposing sides or sections of a cover to various intake and/or exhaust positions.

U.S. Pat. No. 5,797,791 to Humphrey et al. discloses a window vent assembly, wherein the vent is mounted in an opening in a piece of glass. The vent includes a section that is rotatable relative to a frame of the vent, and can be positioned to act as a forced air vent or an exhaust vent.

U.S. Pat. No. 6,106,385, also to Humphrey et al. (“Humphrey '385”) also discloses a rotatable vent (relative to a panel through which the vent is formed). In operation, a user pushes to open or close the vent. Force upon the handle causes a vent plate to pivot, in turn opening or closing a vent cover that is affixed to the vent plate.

### SUMMARY

In one embodiment, a hinged vent unit includes a ceiling garnish for mounting with a ceiling of a vehicle space and a roof flange for mounting with a roof of a vehicle space and with the ceiling garnish, opposite the ceiling garnish. A cover member hinges with the roof flange, for covering or exposing a vent opening formed by the roof flange and ceiling garnish. A lever arm slidingly connected to the cover member and pivotally connected to the roof flange includes or connects with a handle that is serially engagable with a plurality of flange detents and lockable therein. The lever pivots upon retraction of the handle against a biasing member force and backward or forward motion of the handle.

### BRIEF DESCRIPTION OF THE DRAWINGS

FIG. 1 is side perspective view of a hinged vent unit, according to an embodiment.

FIG. 2 is a partial top perspective view of the vent unit of FIG. 1.

FIG. 3 is a top perspective view of a roof mounted flange portion of the vent unit of FIGS. 1 and 2, according to an embodiment.

FIG. 4 is a bottom perspective view of a ceiling garnish portion of the vent unit of FIGS. 1 and 2, according to an embodiment.

FIG. 5 is a partial bottom perspective view of the roof flange portion of FIG. 3, attached with a vent cover and including additional features, according to an embodiment.

FIG. 6 is an enlarged view of a portion of FIG. 5.

FIG. 7 is a bottom perspective view of the roof flange and cover of FIG. 5, showing a screen fitted therewith.

FIG. 8 is a top perspective view of the roof flange and cover of FIG. 7.

FIG. 9 is a partial, bottom view of vent 100 with ceiling garnish 102 removed to show details of a wiring component within roof flange 104.

FIG. 10 is a partial, top view of roof flange 104 showing internal wire routing for a fan switch mounted therewith.

FIG. 11 is a partial, schematic view of the bottom of the roof flange, showing mounting brackets for mounting an additional vent cover, according to an embodiment.

FIG. 12 is a top perspective view of the roof flange, illustrating placement of a seal between the roof flange and vent cover, according to an embodiment.

### DETAILED DESCRIPTION

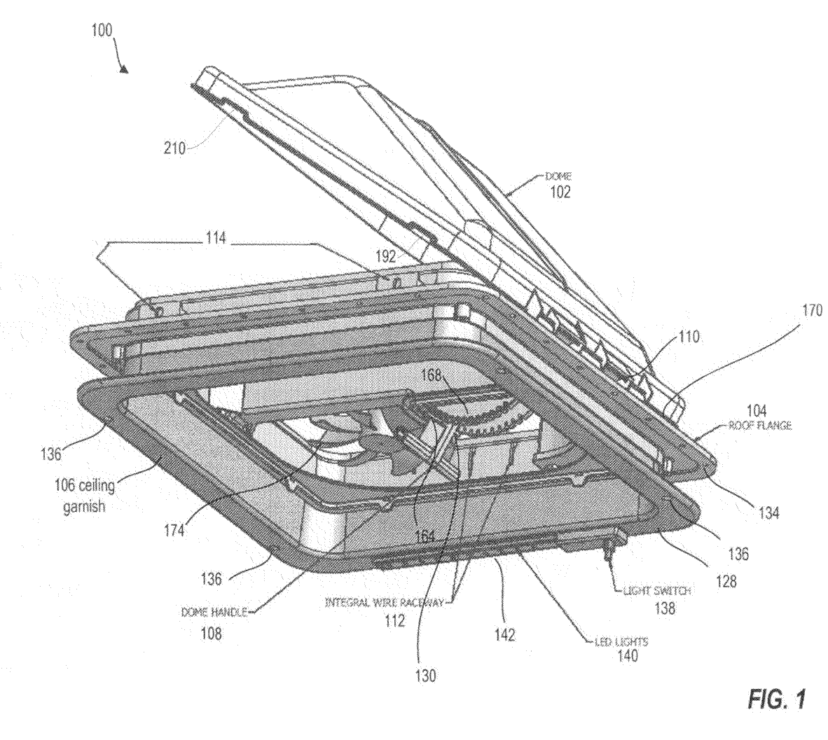

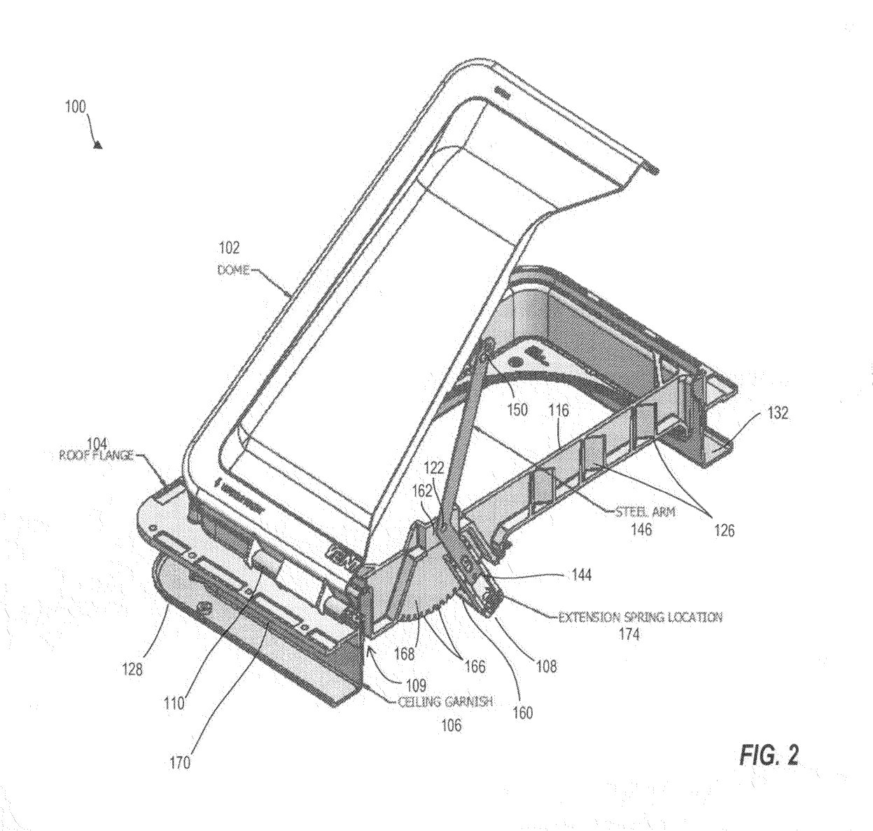

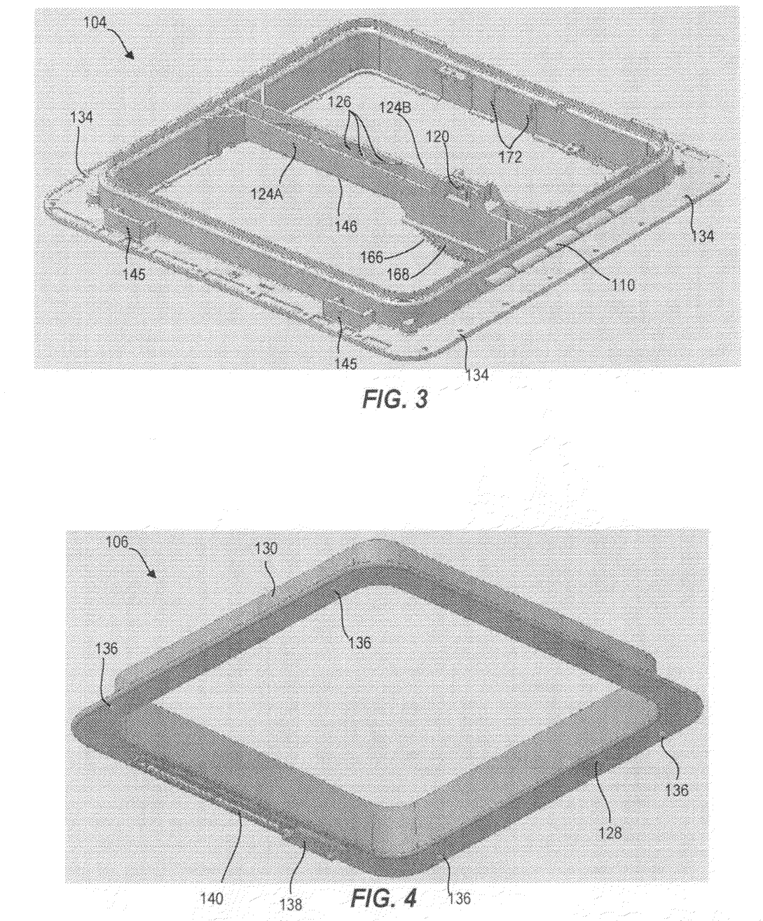

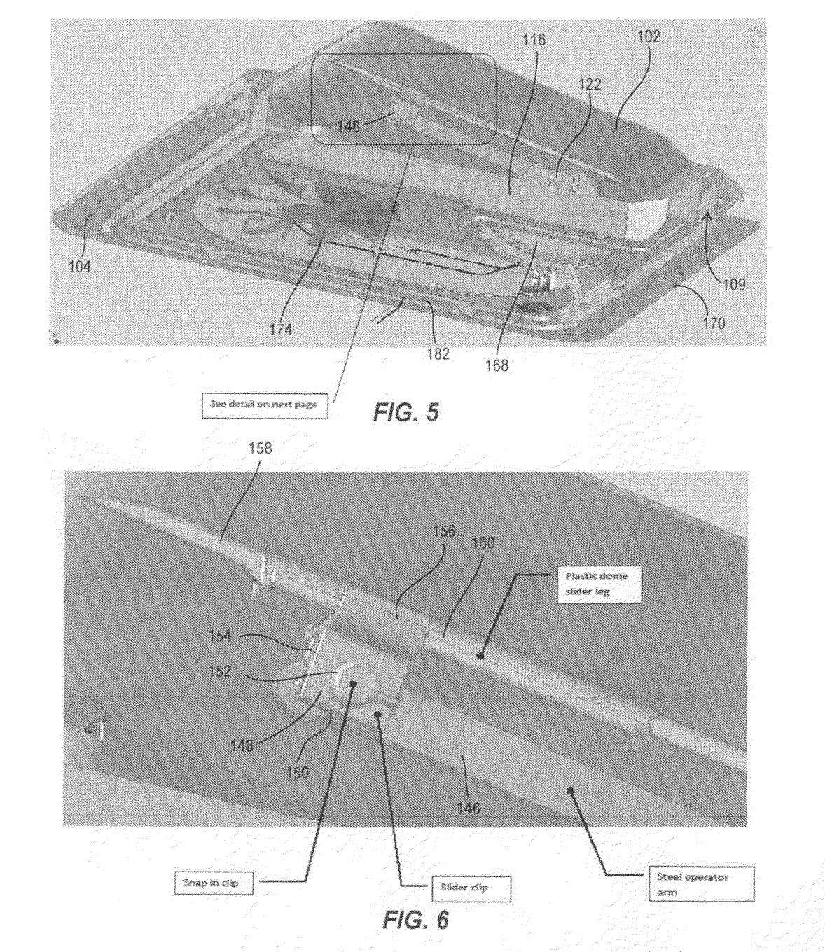

FIGS. 1 and 2 depict a hinged vent unit 100 (or vent 100) including a cover member or domed top 102 (hereinafter, dome 102), a roof flange 104 and a ceiling garnish 106. FIGS. 3 and 4 show additional detail of roof flange 104 and ceiling garnish 106, respectively. For ease of understanding, FIGS. 1-4 are best viewed together with the following description.

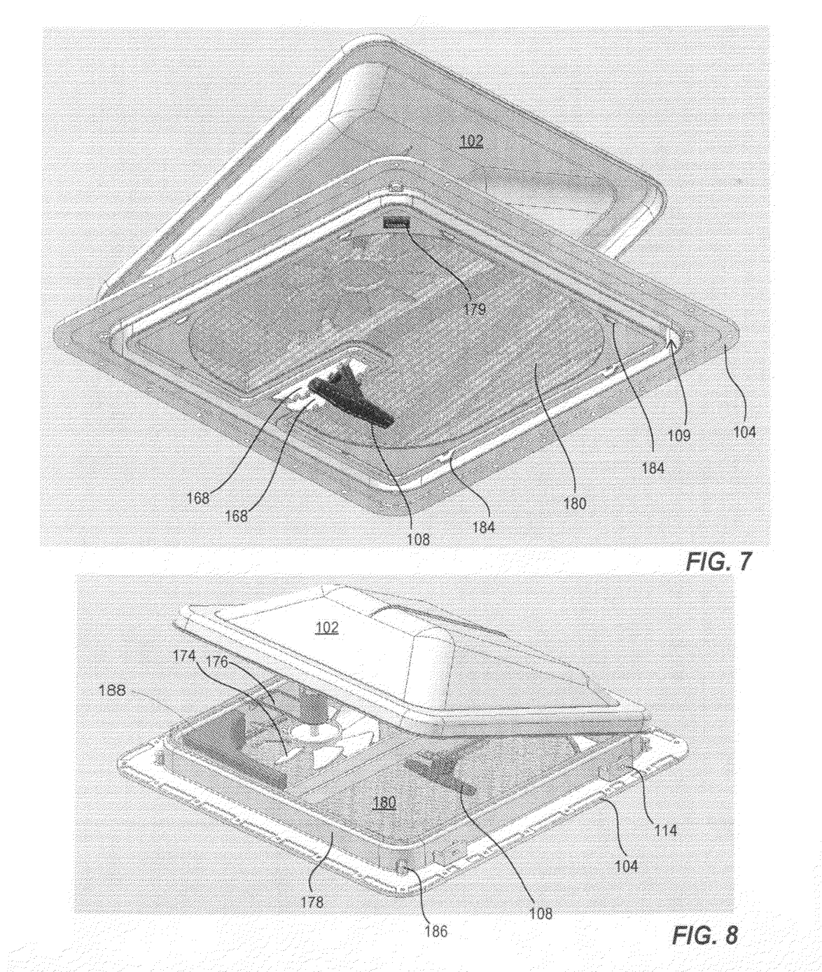

A dome handle 108 (FIG. 1) facilitates opening or closing of dome 102 from within a vehicle or cargo space, for example when vent unit 100 is mounted with the vehicle such that roof flange 104 lies atop the vehicle roof (outside the vehicle) and ceiling garnish 106 mounts with the vehicle ceiling (within the vehicle) and within a garnish pocket 109 of roof flange 104 (see FIGS. 2 and 5).

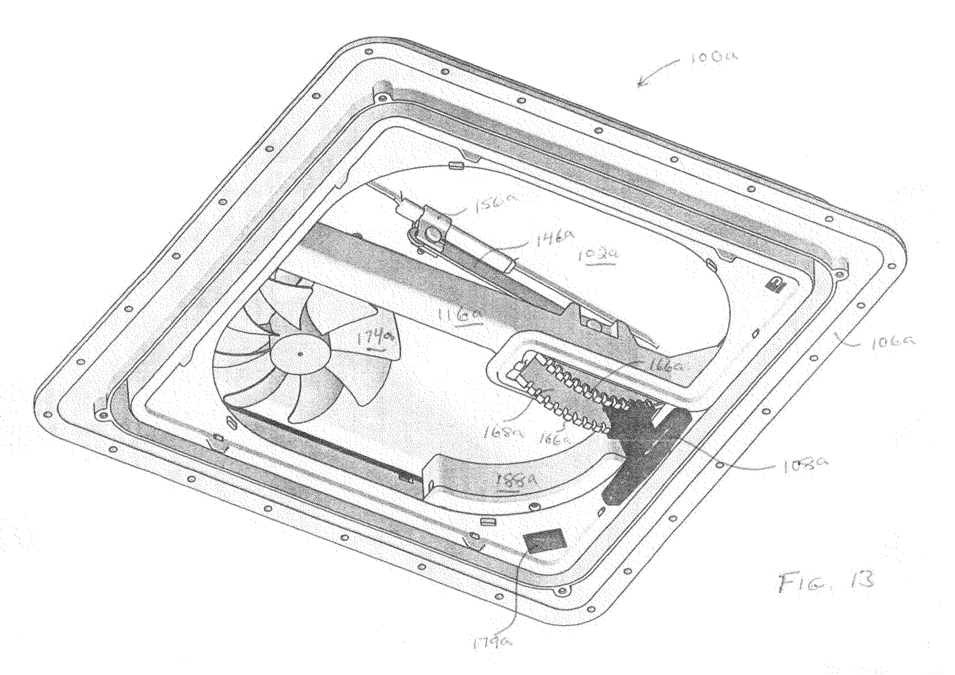

FIG. 3 shows roof flange (or roof-mounted flange) 104. Roof flange 104 includes garnish pocket 109, a flange hinge 110, a raceway 112 for wiring, integral mounting bosses 114 and an operator bar 116 for supporting a medial frame member 168 (shown as an arc 168) and for providing dual apertures 120 (one shown) for connecting with a fastener to form a pivot point 122. In one aspect, operator bar 116 includes opposing bar arms 124 interconnected via supports 126. Discontinuous, diagonal supports 126, as shown in FIG. 3, may strengthen operator bar 116 while adding minimal weight and/or bulk. In one aspect, flange hinge 110, operator bar 116 and garnish pocket 109 are molded into roof flange 104 (i.e., as one part). Mounting bosses 114, which are used to attach roof vent cover brackets (see FIG. 9), may also be formed with or molded into roof flange 104. However, one or more components of roof flange 104 may be formed separately and joined with roof flange 102. In one aspect, roof flange 104 is made of durable plastic such as polypropylene or a thermoplastic olefin (TPO), such that roof flange 104 is compatible with roofing systems and sealants that are incompatible with unprimed steel products. Roof flange 104 is for example formed by extrusion or injection molding. Further options include cast aluminum or zinc. Alternately, where roof flange 104 is made from steel or another metal, it may be powder coated or painted plastic, or an adhesive polypropylene or TPO gasket may be affixed to a roof-contact surface of flange 104.

FIG. 4 is an interior view of ceiling garnish 106, as seen from the bottom. Ceiling garnish 106 includes peripheral ceiling trim 128 extending from an insert 130, sized for fitting into garnish pocket 109 of roof flange 102. Vent 100 is fitted with a vehicle or vehicle space (hereinafter, the “vehicle”) such that roof flange 104 is mounted atop the roof of the vehicle, and ceiling garnish 106 is placed with the vehicle ceiling in alignment with roof flange 104. In particular, an upper face 132 of ceiling trim 128 fits with the vehicle ceiling surrounding a cutout sized to fit vent 100. Insert 130 fits into garnish pocket 109 of roof flange 104, and roof flange 104 and ceiling garnish 106 are fastened together and with the vehicle via a plurality of fasteners. Roof flange 104 for example includes a plurality of apertures 134 that align with a plurality of apertures 136 through ceiling trim 128.

In one aspect, ceiling trim 128 includes a light switch 138 for operating one or more LED lights 140. LED lights 140 are shown arranged with an LED bar 142 along one side of ceiling trim 157; however, it will be appreciated that LED lights 140 may be alternately arranged. For example, LED lights 140 may be placed about the perimeter of ceiling trim 128, proximate each corner of ceiling trim 128 or otherwise arranged with ceiling trim 128.

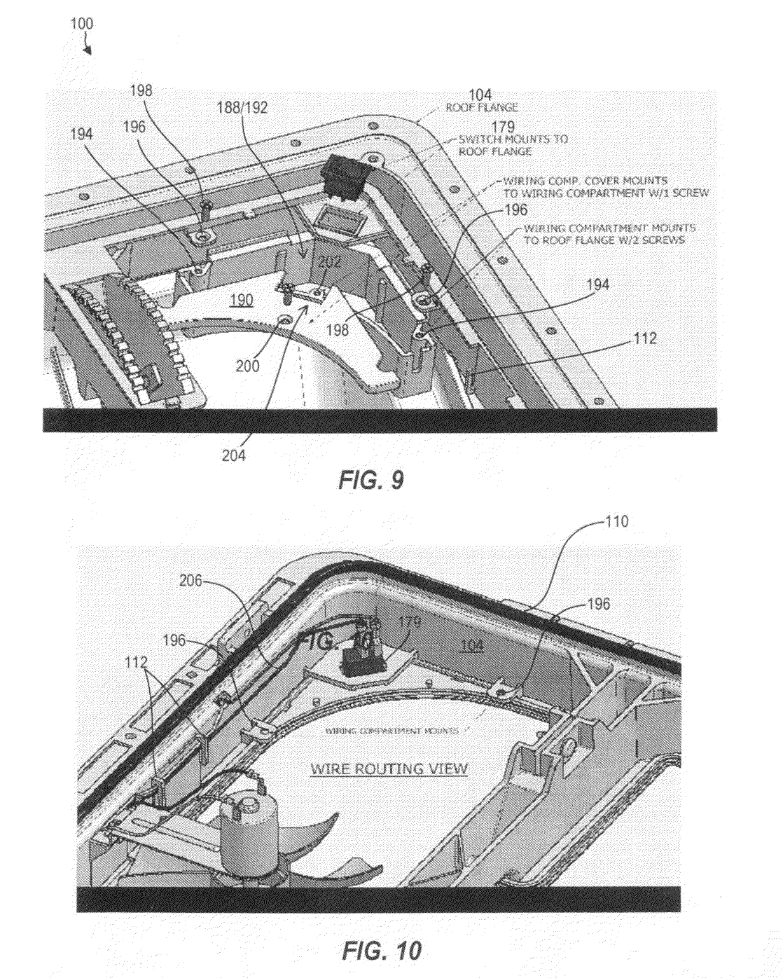

Dome 102 mates with roof flange 104 via flange hinge 110, and is opened or closed via user-operable handle 108 connected with a proximal end 144 of an angled arm 146 (FIG. 2). Arm 146 joins with or is molded with a slide mechanism 148 at a distal end 150 of arm 146. In one aspect, as shown in FIGS. 5 and 6, slide mechanism 148 is a slider clip 148 having a fastener 152 for fastening a slot or notch 154 of clip 148 with distal end 150, and a receptacle 156 opposite fastener 152, for receiving and sliding along a slider leg or rail configured with or attached with the underside of dome 102. Fastener 152 may be a snap in clip or other fastener that pivotally secures slider clip 148 with distal end 150 of arm 146. Arm 146 is for example made of steel.

In one aspect, receptacle 156 slides directly on a rail 158 extending from the underside of dome 102. In another aspect, as shown in FIGS. 5 and 6, rail 158 extends from the underside of dome 102 and a separate slider leg 160 fits with rail 158. Receptacle 156 of slider clip 148 fits over and slides along slider leg 160.

As shown in FIG. 2, arm 146 bends at an elbow 162 proximate pivot point 122 for arm 146. In one aspect, elbow 162 forms an obtuse angle, such that back and forth motion of handle 108 translates to a greater degree of up and down motion of dome 102.

In operation, a user grasps handle 108 and pulls down to release a locking bar 164 (FIG. 1) from detents or teeth 166 of medial member/arc 168 configured with roof flange 104. The user then moves handle 108 forward or backward (with respect to a front end 170 of vent 100) to respectively lower or raise dome 102. Moving handle 108 away from front end 170 causes arm 146 to pivot about pivot point 122 proximate elbow 162, thus exerting upward pressure on dome 102 as slide mechanism 148 moves toward front end 170 along slider leg 160/rail 158, to open vent 100. Moving handle 108 towards front end 170 in turn moves slide mechanism 148 away from front end 170 (again, along slider leg 160/rail 158), closing vent 100. When dome 102 is opened or closed to the desired degree, the user releases downward pressure on handle 108 to engage and secure locking bar 164 with teeth 166 of arc 168. Tension provided by an extension spring at a lateral position 172 between handle 108 and proximal end 144 of arm 146 (or by dual springs at opposing sides of handle 108, between handle 108 and distal end 150 of arm 146) biases locking bar 164 against teeth 166, to hold handle 108 in place. The wedge shape of dome 102 accommodates function of slide mechanism 148 along slider leg 160/rail 158, and may also enhance aerodynamics and appearance of vent 100.

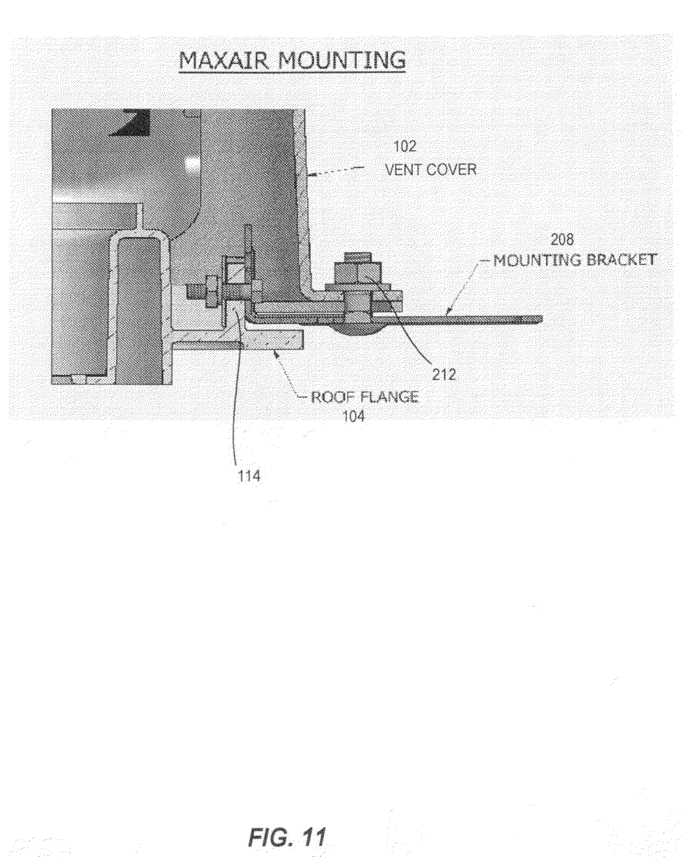

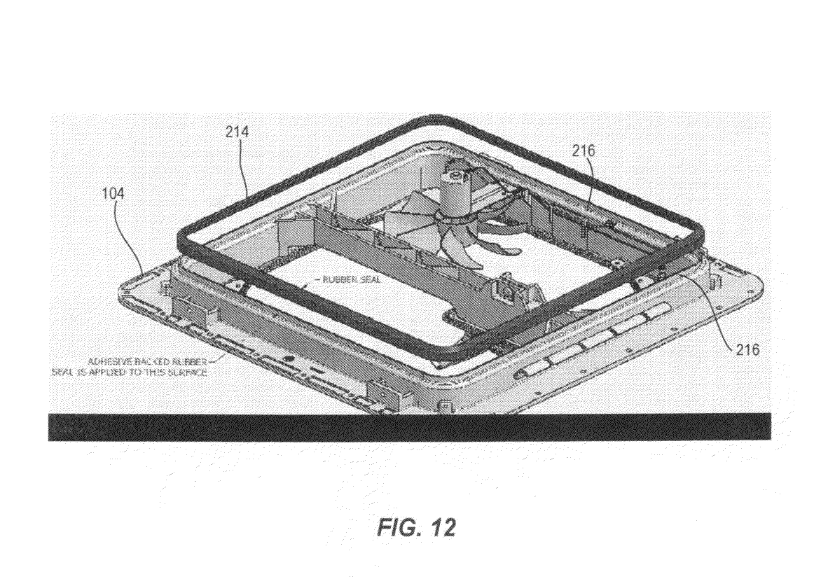

As shown in FIGS. 7 and 8 (among others), roof flange 104 may support a fan 174 for enhancing air circulation via vent 102. In one aspect, fan 174 is supported on a fan extension 176 extending from an inner aspect .of a peripheral side wall 178 of roof flange 104. Fan 174 may be a passive fan, or fan 174 may be activated by a user, for example by pressing a button or flipping or sliding a switch, such as switch 179, configured with vent 100. In one example, a user slides a switch or presses a button on ceiling trim 128 to turn on, turn off or change direction of the fan (i.e., to encourage air intake or exhaust). It will be appreciated that power would be provided to a user-activated fan, for example via suitable wiring run through raceway 112 and/or an additional raceway, the wiring being in communication with the fan button, switch or slide.

Roof flange 104 may also support a screen 180 for preventing solid matter from entering the vehicle while dome 102 is open. Screen 180 may be inserted into or removed from an internal track 182 of roof flange 180 via a plurality of tabs 184. In addition, roof flange 104 may include one or more placement features 186 (for example, pegs or surface features) for aligning with complementary placement features within dome 102, to encourage proper alignment between dome 102 and roof flange 104 as vent 100 closes.

It will be appreciated that although not specified above, dome 102 may include cut-outs, protrusions or other features for aligning with and/or accommodating features of roof flange 104.

Turning to FIG. 8, a wiring junction box 188 (or field service wiring component 188) may be incorporated for use when a Canadian Standards Association (“CSA”) or Underwriters Laboratories Inc. (“UL) product listing is required. According to code, a junction box switch cannot be mounted in the junction box cover, and the box must be made of flame retardant/self-extinguishing plastic rated UL V0 grade. Existing plastic vents make the entire vent or vent housings out of the V0 grade plastic, in order comply with UL standards. This adds significant cost to the plastic vents, as UL V0 grade plastic is expensive.

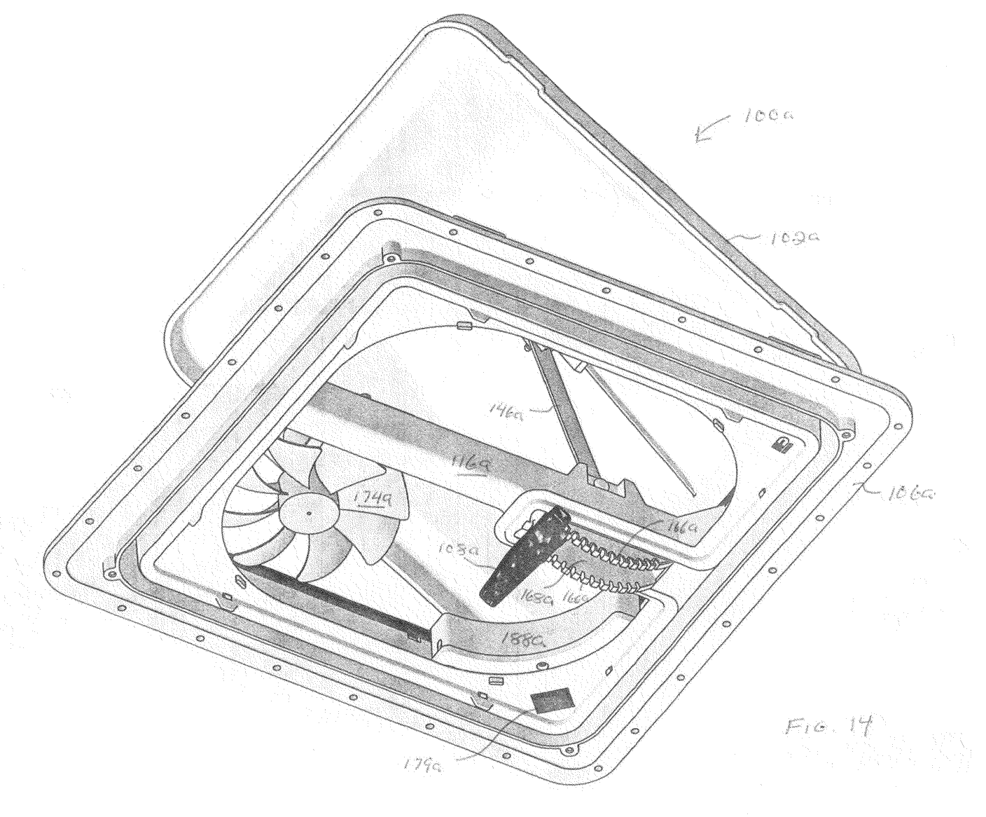

Vent 100 may provide significant cost reduction and ease of installation/removal by providing a switch mounted into the vent frame. For example, as shown in FIGS. 9 and 10, switch 179 mounts with roof flange 104. Junction box 188 and a cover 190 surround switch 179 and cover its non user-actuable portion; however, switch 179 is mounted to flange 104 and not within junction box 188. Junction box 188 creates a wiring compartment 192 for supply wiring hookup. Therefore, junction box 188/wiring compartment 192 and cover 190 may be installed and/or removed even after switch 179 is inserted and wired. As such, only wiring compartment 192 need be flame retardant. Roof flange 104 itself may be made of an alternate, less expensive material (for example, one with a UL flame rating of 94 HB), without vent 100 violating UL requirements. Hereinafter, “junction box 188” and “wiring compartment 192” may be used interchangeably.

In one aspect, wiring compartment 192 forms opposing lateral apertures 194, which align with opposing apertures formed by wiring mounts 196 that are integral to or mounted within roof flange 104 when junction box mounts with roof flange 104. Wiring compartment 192 may thus be secured to roof flange 104 with two screws (e.g., screws 198, as shown). Cover 190 includes an aperture 200 that aligns with an aperture 202 of junction box 188/wiring compartment 192 and includes a cutout 204 for surrounding, but not covering, switch 179. As such, cover 190 may be joined with wiring compartment 192 via a single screw, wiring compartment 192 surrounds switch 179, yet switch 179 is mounted with roof flange 104, and not with junction box 188. A user need only place or remove three screws to install or remove junction box 188, and need only remove one screw to access wiring 206 within junction box 188 (see FIG. 10).

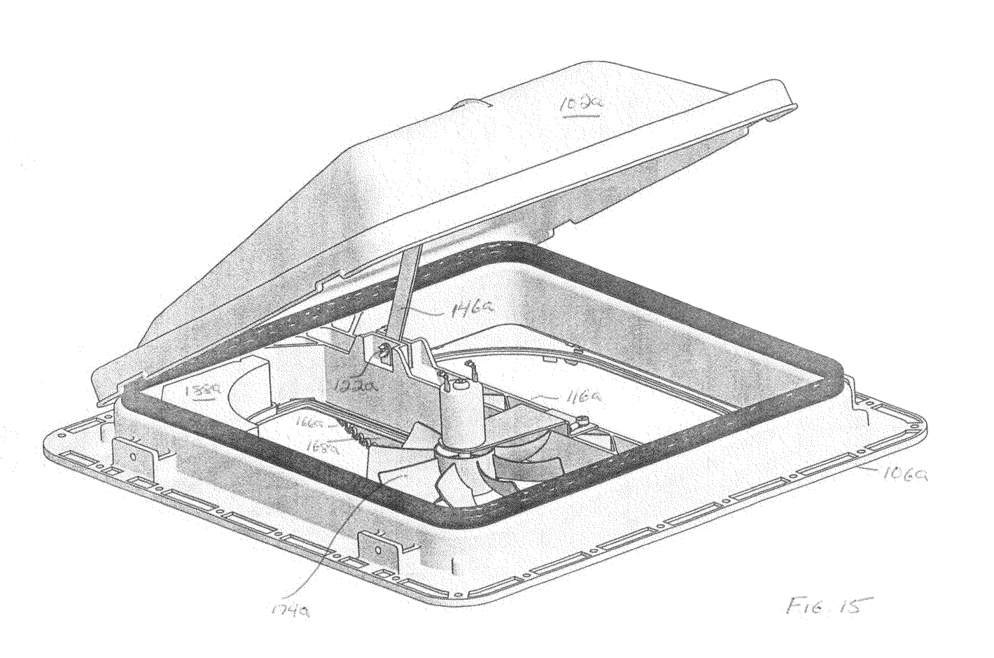

As shown in FIG. 11, mounting bosses 114 of roof flange 104 provide for connection of mounting brackets 208, which in turn support an additional vent cover (not shown). In one aspect, the additional vent cover fits over vent 100 (i.e., over dome 102), such that vent 100 (dome 102) may be opened to allow light into the vehicle or vehicle space while keeping precipitation out. As such, the additional cover may be a translucent cover. Offsets 210 in dome 102 (FIG. 1) provide clearance for mounting hardware 212 to be attached with mounting bosses 114.

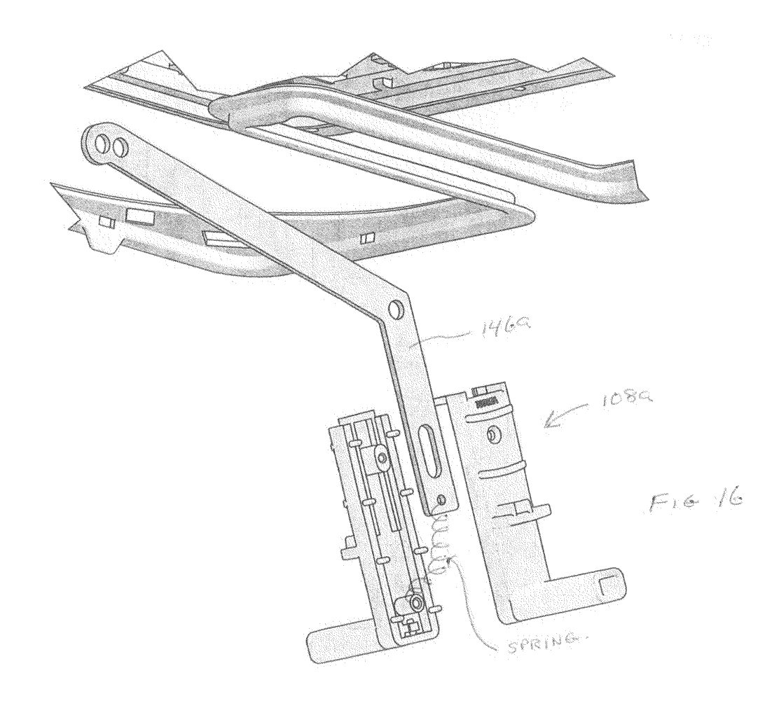

Vent 100 may feature or support an additional seal 214 between dome 102 and roof flange 104. As shown in FIG. 12, an upper aspect of roof flange 104 may include an outer partial channel or shelf 216 for accommodating a gasket/seal 218. Seal 218 may be an adhesive-backed rubber seal sized to fit with channel or shelf 216. Although not shown, dome 102 may include a complementary inner shelf or channel for fitting with the top surface of seal 218.

While the present invention has been described above, it should be clear that many changes and modifications may be made to the process and product without departing from the spirit and scope of this invention.

What is claimed is:

1. A vent comprising:
a ceiling garnish for mounting with a ceiling of a vehicle space;
a roof flange for mounting with a roof of a vehicle space and with the ceiling garnish, opposite the ceiling garnish;
a cover member hinged to the roof flange for covering a vent opening formed by the roof flange and ceiling garnish; and
a lever slidingly connected to the cover member and pivotally connected to the roof flange, the lever having a handle serially engagable with a plurality of flange detents and lockable therein; the lever pivotally moveable upon retraction of the handle against a biasing member force.

2. The vent of claim l further comprising a fan mounted with the roof flange, the air movement device coverable by the cover member.

3. The vent of in claim 1 further comprising one or more light emitting devices embedded in the ceiling garnish.

4. The vent of claim 3, the ceiling garnish further comprising a switch or button for controlling the light emitting devices.

5. The vent of claim 1 further comprising a wire retention member configured with an inner surface of the roof flange.

6. The vent of claim 1 further comprising a seal between the cover and the roof flange.

7. The vent of claim 1, wherein the frame detents are disposed on a medial frame member.

8. The vent of claim 1, wherein the frame detents are arranged in an arcuate orientation.

9. The vent of claim 1 further comprising a seal attached to an outer surface of the roof flange.

10. The vent of claim 1, wherein the cover member has a sloped or domed surface with respect to the horizontal.

11. The vent of claim 1, the roof flange being molded or formed from plastic.

12. A vent comprising:
a ceiling garnish for mounting with a ceiling of a vehicle space;
a roof flange for mounting with a roof of a vehicle space and with the ceiling garnish, opposite the ceiling garnish; the roof flange including a fan switch mounted therewith, for controlling a fan mounted with the roof flange;
a junction box for covering a wiring compartment within the roof flange and proximate the switch, the junction box surrounding but not supporting the fan switch;
a cover member hinged to the roof flange for covering a vent opening formed by the roof flange and ceiling garnish; and
a lever slidingly connected to the cover member and pivotally connected to the roof flange, the lever having a handle serially engagable with a plurality of flange detents and lockable therein; the lever pivotally moveable upon retraction of the handle against a biasing member force.

13. The vent of claim 12, wherein the junction box is formed of a high grade flame retardant plastic, and the roof flange is formed of a lower grade flame retardant plastic.
